(19) United States
(12) Patent Application Publication
(10) Pub. No.: US 2026/0254329 A1
(43) Pub. Date: Aug. 27, 2026

(54) ROTOR MANUFACTURING DEVICE

(71) Applicant: TOYOTA BOSHOKU KABUSHIKI KAISHA, Aichi-ken (JP)

(72) Inventors: Yuto ITO, Takahama-shi (JP); Yuki WAKIMOTO, Tokai-shi (JP); Kosuke SEGI, Kariya-shi (JP)

(73) Assignee: TOYOTA BOSHOKU KABUSHIKI KAISHA, Aichi-ken (JP)

(21) Appl. No.: 19/541,880

(22) Filed: Feb. 17, 2026

(30) Foreign Application Priority Data
Feb. 25, 2025 (JP) 2025-027978

(51) Int. Cl. H02K 15/121; H02K 15/035

(52) U.S. Cl. CPC H02K 15/121; H02K 15/035; H02K 2215/00

(57) ABSTRACT

A rotor manufacturing device includes a sprue configured to be connected to a nozzle of an injection device, gates, and a runner portion connecting the sprue and the gates. The runner portion includes flow passages. Each of the flow passages includes two first portions respectively extending from two of the gates, and a second portion connected to the two first portions and extending from the first portions to an upstream side in a flowing direction of the resin material. In each of the flow passages, at least one of the two first portions is connected to one of two first portions of one of the flow passages that is adjacent in the circumferential direction.

### CROSS-REFERENCE TO RELATED APPLICATIONS

This application is based upon and claims the benefit of priority from Japanese Patent Application No. 2025-027978, filed on February 25, 2025, the entire contents of which are incorporated herein by reference.

### BACKGROUND

### 1. Field

The present disclosure relates to a rotor manufacturing device.

### 2. Description of Related Art

JP2024-179660A discloses a rotor for a magnet-embedded motor. The rotor includes a cylindrical rotor core having slots, a magnet accommodated in each slot, and a resin portion that fills each slot and fixes the corresponding magnet to the rotor core. The resin portion is formed from a thermoplastic resin material. In a state in which each magnet is fitted in the corresponding slot, the resin portion is formed by filling, with the resin material, two gaps respectively extending from the two short sides of the magnet to the inner walls of the slot.

In such a rotor, the slots and the magnets may have varying dimensions, which, in turn, varies the volumes of the two gaps in each slot. As a result, even if the resin material is injected evenly into each slot, there may be a difference between the slots in the time taken to fill the slot with the resin material.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a device for manufacturing a rotor is provided. The rotor includes a rotor core having slots arranged in a circumferential direction, and magnets respectively accommodated in the slots such that each of the magnets is sandwiched by two gaps in a width direction of the corresponding one of the slots. In a state in which the magnets are accommodated in the slots, the device is configured to fill the two gaps of each of the slots with a thermoplastic resin material to fix the magnets to the rotor core and manufacture the rotor. The manufacturing device includes a sprue configured to be connected to a nozzle of an injection device that injects the resin material, gates, each facing one of the gaps in an axial direction of the rotor core in each of the slots, and a runner portion connecting the sprue and the gates. The runner portion includes flow passages. Each of the flow passages includes two first portions respectively extending from two of the gates respectively facing two of the gaps, and a second portion connected to the two first portions and extending from the first portions to an upstream side in a flowing direction of the resin material. In each of the flow passages, at least one of the two first portions is connected to one of two first portions of one of the flow passages that is adjacent in the circumferential direction.

Other features and aspects will be apparent from the following detailed description, the drawings, and the claims.

### BRIEF DESCRIPTION OF THE DRAWINGS

FIG. 1 is a plan view showing an embodiment of a rotor manufacturing device.

FIG. 2 is an enlarged plan view of a portion shown in FIG. 1.

FIG. 3 is a plan view showing a modification of a rotor manufacturing device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

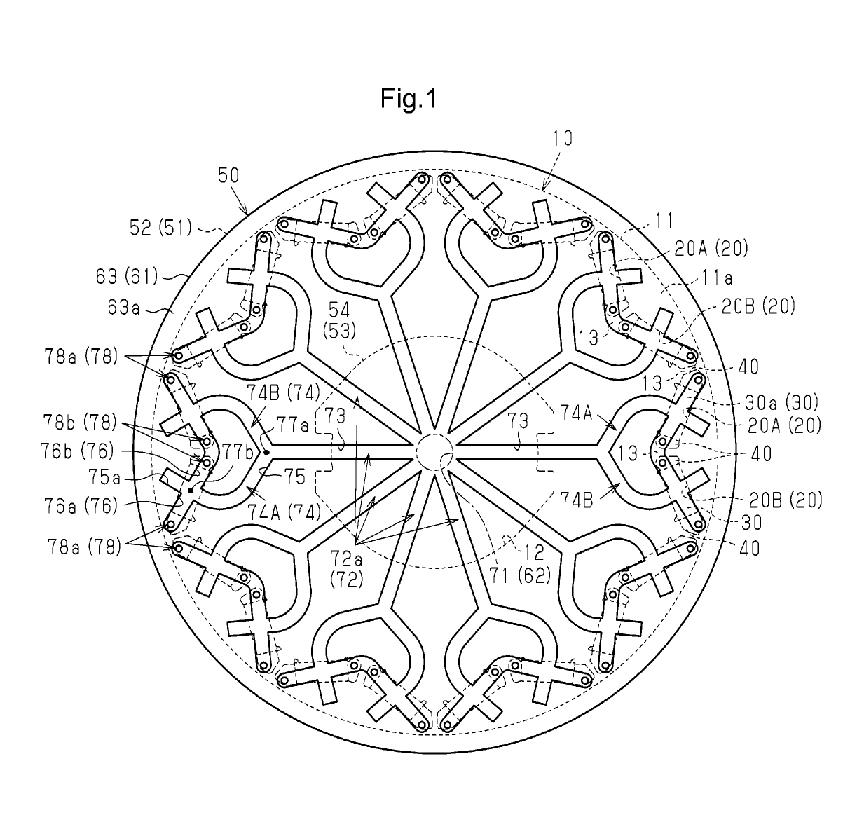

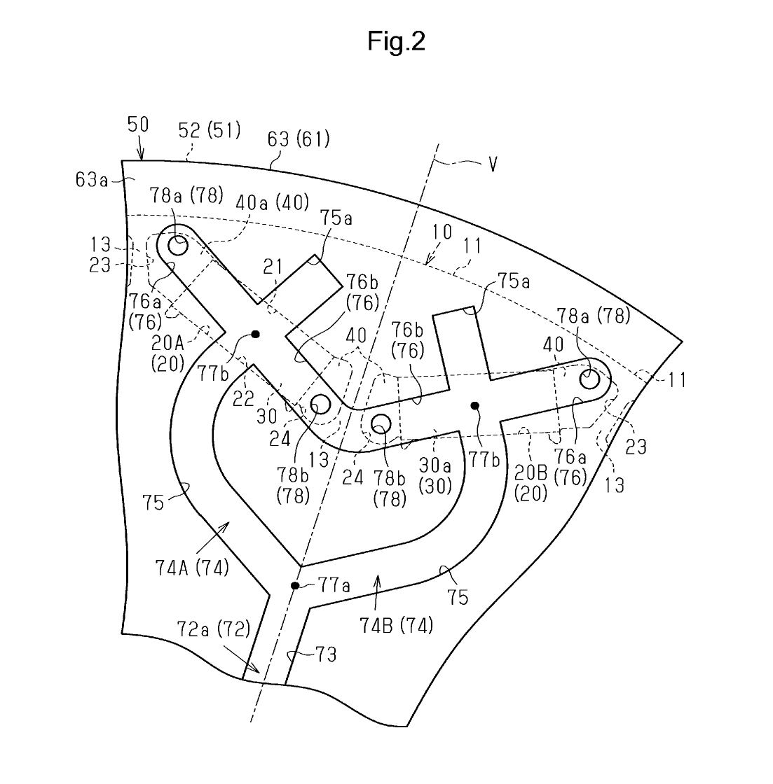

An embodiment of a rotor manufacturing device will now be described with reference to FIGS. 1 and 2.

A rotor 10 manufactured by a manufacturing device 50 of the present embodiment will now be described.

### Rotor 10

As shown in FIGS. 1 and 2, the rotor 10 includes a rotor core 11, magnets 30, and resin portions 40. The rotor 10 is, for example, used in a magnet-embedded motor. The rotor core 11 is cylindrical. The rotor core 11 is, for example, formed by stacking iron core pieces that are punched out from a magnetic steel sheet. In the following description, the axial direction of the rotor core 11 will simply be referred to as the axial direction. Further, the radial direction of the rotor core 11 will simply be referred to as the radial direction. Additionally, the circumferential direction of the rotor core 11 will simply be referred to as the circumferential direction. The rotor core 11 includes a center hole 12, into which a shaft is inserted, and slots 20, which accommodate the magnets 30. The center hole 12 and the slots 20 extend through the rotor core 11 in the axial direction. That is, each of the center hole 12 and the slots 20 opens in an axial end surface 11a of the rotor core 11. The open portion of each slot 20 is substantially rectangular and includes long and short sides.

As shown in FIGS. 1 and 2, each slot 20 includes a set of a first slot 20A and a second slot 20B. The slots 20 are spaced apart and arranged in the circumferential direction. Further, a bridge 13 extends between the slots 20A and 20B that are adjacent to each other in the circumferential direction.

As shown in FIG. 2, in the present embodiment, each set of slots 20A and 20B are arranged so that they converge toward the center hole 12, thereby forming a V shape in plan view. In the present embodiment, each set of slots 20A and 20B extend in the radial direction and the axial direction so that the slots 20A and 20B are symmetrical to each other with respect to an imaginary plane V lying along the circumferentially center point between the slots 20A and 20B. Since the slots 20A and 20B are identical in structure in the following description, only the first slot 20A will be described as the slot 20 and the second slot 20B will not be described.

As shown in FIG. 2, an inner surface of the slot 20 includes a first surface 21 and a second surface 22 that face each other in the thickness direction of the slot 20. The first surface 21 is located radially outward from the second surface 22. The thickness direction corresponds to the lateral direction, which is the direction in which the long sides of the slot 20 face each other. The direction orthogonal to both the axial direction and the thickness direction is referred to as the width direction of the slot 20. The width direction corresponds to the longitudinal direction, which is the direction in which the short sides of the slot 20 face each other.

As shown in FIGS. 1 and 2, a single magnet 30 is accommodated in each slot 20. The magnet 30 is fixed to the rotor core 11 by the resin portions 40 that are formed by filling the slot 20 with resin material. The magnet 30 is, for example, a permanent magnet. Each magnet 30 is elongated in the axial direction. The magnet 30 includes an axial end surface 30a that is, for example, flush with the axial end surface 11a. The axial end surface 30a of the magnet 30 is rectangular and has long and short sides. The magnet 30 is accommodated in the slot 20 in a state in which the longitudinal direction and the lateral direction of the axial end surface 30a of the magnet 30 coincide with the width direction and thickness direction of the slot 20, respectively.

As shown in FIG. 2, the magnet 30 includes two end surfaces in the width direction that are spaced apart by gaps from the walls of the slot 20. Accordingly, in a state in which the magnet 30 is accommodated in the slot 20, the slot 20 includes a first gap 23 and a second gap 24 located at the opposite sides of the magnet 30 in the width direction. In the present embodiment, the first gap 23 has a greater opening area and volume than the second gap 24. The magnet 30 also includes two end surfaces in the thickness direction that are respectively spaced apart by gaps from the first surface 21 and the second surface 22 of the slot 20. Each of these gaps have a dimension in the thickness direction that is small enough to keep out the resin material of the resin portion 40 as long as the resin material is not filled at a pressure greater than or equal to a predetermined value. Thus, in the present embodiment, the resin material does not enter and does not form the resin portion 40 in the two gaps in the thickness direction of the slot 20.

As shown in FIG. 2, the resin portion 40 is formed in each of the gaps 23 and 24 of the slot 20. The resin portion 40 includes an axial end surface 40a, at one side in the axial direction, that is flush with the axial end surface 30a of the magnet 30 and the axial end surface 11a of the rotor core 11. The resin material of the resin portion 40 is, for example, a thermoplastic resin such as a liquid crystal polymer.

### Manufacturing Device 50

The manufacturing device 50 of the rotor 10 will now be described. The manufacturing device 50 is a molding device that fills the slot 20 with the resin material of the resin portion 40.

As shown in FIG. 1, the manufacturing device 50 includes a first mold 51 and a second mold 61. The first mold 51 includes a first mold body 52 and a pallet 53. The pallet 53 is arranged between the first mold body 52 and the second mold 61 in a state in which the pallet 53 supports the rotor core 11. The pallet 53 includes a base plate (not shown) and a post 54. The base plate supports the axial end surface of the rotor core 11 opposite the axial end surface 11a. The post 54 is cylindrical and projects from the central portion of the base plate. The post 54 is inserted into the center hole 12 of the rotor core 11.

As shown in FIG. 1, the second mold 61 includes a second mold body 62 and a gate plate 63. In the present embodiment, the second mold body 62 is formed separately from the gate plate 63. The second mold body 62 is moveable toward and away from the first mold body 52. The central portion of the second mold body 62 includes a sprue 71 connected to a nozzle (not shown) of an injection device that injects the resin material of the resin portion 40. The gate plate 63 is located between the second mold body 62 and the rotor core 11.

As shown in FIGS. 1 and 2, the gate plate 63 includes gates 78 facing the slots 20 in the axial direction, and a runner portion 72 that connects the sprue 71 to the gates 78. The gates 78 open in the axial end surface (not shown) of the gate plate 63 connecting the runner portion 72 to the slots 20. The gates 78 are located at positions facing the gaps 23 and 24 of the slots 20. In the following description, a gate 78 facing a first gap 23 will be referred to as a first gate 78a, and a gate 78 facing the second gap 24 will be referred to as a second gate 78b.

The runner portion 72 is a recess that opens in an axial end surface 63a at the other side of the gate plate 63. The runner portion 72 form ten flow routes 72a extending radially from the sprue 71 (refer to FIG. 1). In the following description, the upstream side and the downstream side with respect to the direction in which the resin material of the resin portion 40 flows from the sprue 71 to the gates 78 through the flow routes 72a will simply be referred to as the upstream side and the downstream side. In the present embodiment, the flow routes 72a are not connected to each other in the flowing direction. In other words, the flow routes 72a that are adjacent to each other in the circumferential direction are independent from each other. Each flow route 72a includes, in order from the upstream side, a third portion 73 and branch flow passages 74, each having a second portion 75 and two first portions 76. The third portion 73 extends linearly from the sprue 71 in the radial direction.

As shown in FIG. 2, each flow route 72a includes two branch flow passages 74. Each of the two branch flow passages 74 is branched from the downstream end of the third portion 73 and extends toward one of the slots 20A and 20B. In the following description, the branch flow passage 74 extending to the slot 20A will be referred to as a first branch flow passage 74A and the branch flow passage 74 extending to the slot 20B will be referred to as a second branch flow passage 74B. The branch flow passages 74A and 74B are symmetrical with respect to the imaginary plane V, in the same manner as the slots 20A and 20B. Since the first branch flow passage 74A and the second branch flow passage 74B are identical in structure, only the first branch flow passage 74A will be described as the branch flow passage 74, and the second branch flow passage 74B will not be described. The second portion 75 is branched from the downstream end of the third portion 73 and extends outward in the radial direction. The downstream end of the third portion 73 includes a second connection point 77a connected to the second portion 75 of the first branch flow passage 74A and the second portion 75 of the second branch flow passage 74B. The second portion 75 is curved. Specifically, the central part of the second portion 75 with respect to the flowing direction is curved away from the imaginary plane V in the circumferential direction.

As shown in FIG. 2, the two first portions 76, branched from the second portion 75, are respectively connected to the gates 78a and 78b. In the following description, the first portion 76 connected to the gate 78a will be referred to as a first portion 76a, and the first portion 76 connected to the second gate 78b will be referred to as a first portion 76b. The first portion 76a extends from the second portion 75 opposite the first portion 76b. The first portions 76a and 76b are both orthogonal to the second portion 75. In the present embodiment, a part of the second portion 75 at which the first portions 76a and 76b are connected (hereinafter, a first connecting portion 77b) is located at a position overlapping the central portion of the first slot 20A in the width direction and the axial direction. The second portion 75 includes an extension 75a extending toward the downstream side from the first connecting portion 77b. The extension 75a allows the resin material of the resin portion 40 flowing from the second portion 75 to the first connecting portion 77b to be released into the second portion 75 in the flowing direction. In the present embodiment, the first portions 76b of the branch flow passages 74A and 74B are connected to each other.

### Operation of Present Embodiment

The resin material of the resin portion 40 injected from the injection device to the sprue 71 flows through the runner portion 72 and is injected from the gates 78 into the slots 20. In the branch flow passages 74A and 74B of the flow route 72a, the resin material of the resin portions 40 flows toward the gates 78a and 78b through the second portion 75, branched into the first portion 76a and 76b. Further, the gates 78a and 78b face the gaps 23 and 24 of the slot 20 in the axial direction. Thus, the resin material is directly injected into the gaps 23 and 24 from the gates 78a and 78b. Accordingly, less pressure is applied when filling the resin material (hereinafter, filling pressure) than when, for example, the resin material of the resin portion 40 fills the slot 20 around the entire outer surface of the magnet 30. Additionally, the filling pressure acts only on the portion of the inner surface of each slot 20 forming the gaps 23 and 24. In comparison with when the filling pressure acts on the entire inner surface of the slot 20, which includes the first surface 21 and the second surface 22, less filling pressure is applied to the bridges 13, which are located between the adjacent slots 20, and the rotor core 11. This avoids deformation of the bridges 13 and the rotor core 11.

Furthermore, in the manufacturing device 50 in accordance with the present embodiment, the first portion 76b of the second branch flow passage 74B is connected to the adjacent first portion 76b of the first branch flow passage 74A in the circumferential direction. Therefore, the adjacent branch flow passages 74A and 74B, which are connected to each other in the circumferential direction, function as a single flow passage. Accordingly, the connected branch flow passages 74A and 74B allow the slots 20 to be filled with the resin material of the resin portion 40 over the same time.

### Advantages of Present Embodiment

(1) The runner portion 72 includes the branch flow passages 74. Each branch flow passage 74 includes the first portions 76a and 76b, extending from the corresponding gates 78a and 78b, and the second portion 75, which is connected to the first portions 76a and 76b and extends from the first portions 76a and 76b to the upstream side in the flowing direction of the resin material of the resin portion 40. The first portion 76b of the first branch flow passage 74A is connected to the adjacent first portion 76b of the second branch flow passage 74B in the circumferential direction.

The above-described configuration operates in the above-described manner. This limits the difference in the time at which the resin material is filled into the slots 20 between the branch flow passages 74A and 74B.

(2) The runner portion 72 includes the flow routes 72a. Each flow route 72a includes the branch flow passages 74A and 74B, which are adjacent in the circumferential direction, and the third portion 73, which is connected to the two second portions 75 of the branch flow passages 74A and 74B and extends toward the upstream end from the second portion 75 in the flowing direction and is connected to the sprue 71.

According to this structure, each flow route 72a extending from the sprue 71 includes the third portion 73 and the branch flow passages 74A and 74B branched from the third portion 73. Thus, compared to when the runner portion 72 is a flow passage extending directly to the slots 20 from the sprue 71, there are less flow passages; that is, the volume of the runner portion 72 is reduced. Accordingly, the yield is improved.

### Modifications

The present embodiment may be modified as follows. The present embodiment and the following modifications can be combined as long as they remain technically consistent with each other.

In the runner portion 72, the first portions 76b of the branch flow passages 74A and 74B do not have to be connected to each other in each flow route 72a, as exemplified in the present embodiment. For example, the runner portion 72 may be formed so that the first portions 76a of flow routes 72a adjacent in the circumferential direction are connected to each other. In this case, the flow routes 72a do not have to extend independently from one another and may be connected to the adjacent flow routes 72a.

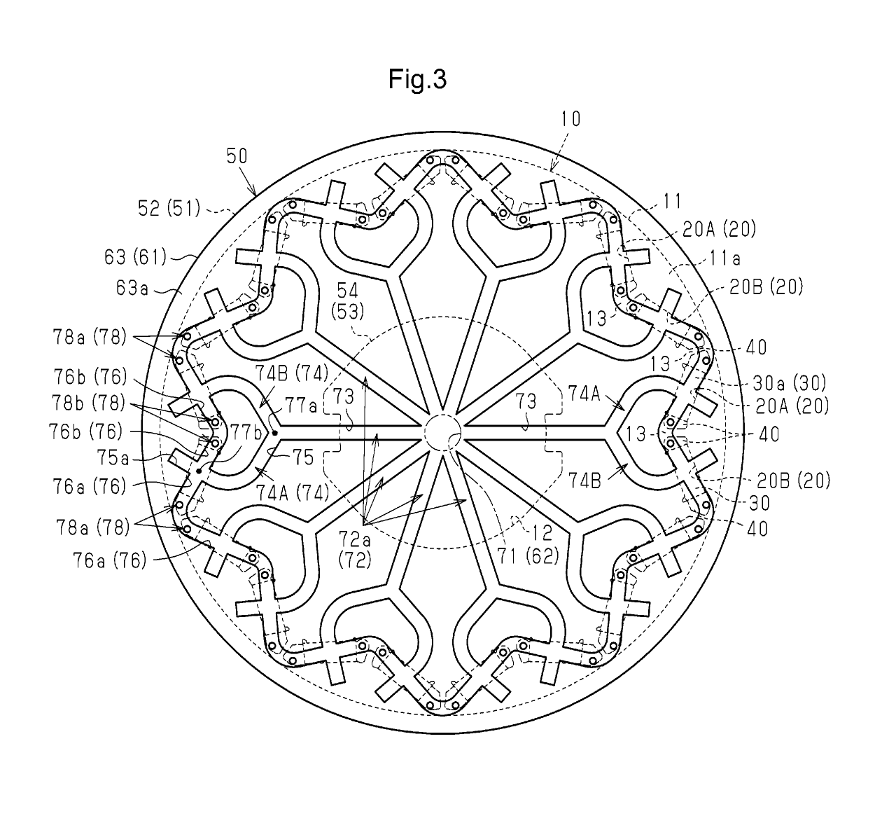

As shown in FIG. 3, the runner portion 72 may be formed such that one of the two first portions 76 of each flow passage (branch flow passage 74) is connected to one of the two first portions 76 of one of the flow passages (branch flow passage 74) that is adjacent to the flow passage (branch flow passage 74) in one side in the circumferential direction, and the other one of the two first portions 76 of each flow passage (branch flow passage 74) is connected to one of the two first portions 76 of one of the flow passages (branch flow passage 74) that is adjacent to the flow passage (branch flow passage 74) in other side in the circumferential direction. In other words, the first portions 76b adjacent in the circumferential direction may be connected to each other in the runner portion 72, and the first portions 76a adjacent in the circumferential direction may be connected to each other.

According to this structure, the branch flow passages 74 are connected to each other over the entire circumferential direction in the runner portion 72. This allows the slots 20 to be filled with the resin material at the same time. This limits differences in the times at which the resin material is filled into each slot 20.

The extension 75a may be omitted from each of the branch flow passages 74A and 74B.

In the branch flow passage 74A, the first portions 76a and 76b do not have to extend orthogonal to the second portion 75 as long as they intersect the second portion 75.

The branch flow passage 74A does not have to be located at a position in the axial direction overlapping the central portion of the slot 20A of the first connecting portion 77b in the width direction as exemplified in the present embodiment. In other words, the branch flow passage 74A may be branched into the first portions 76a and 76b from any part of the second portion 75 in the flowing direction.

In the flow route 72a, the branch flow passages 74A and 74B do not need to be symmetrical with respect to the imaginary plane V as exemplified in the present embodiment, and may be asymmetrical.

In the runner portion 72, the single flow route 72a extending toward the slots 20A and 20B does not have to be V-shaped as exemplified in the present embodiment. For example, the runner portion 72 may include a single flow route 72a extending toward the slots 20A and 20B in an inverted V shape.

The runner portion 72 may include a single flow route 72a for each slot 20. In this case, the third portion 73 may be omitted from the flow route 72a, and the upstream end of the second portion 75 may be connected directly to the sprue 71.

With regard to the gaps 23 and 24 formed in each slot 20, the first gap 23 does not need to have a larger opening area and larger volume than the second gap 24 as exemplified in the present embodiment. For example, the opening area and the volume of the first gap 23 may be smaller than the second gap 24. Further, the first gap 23 and the second gap 24 may have the same opening area and volume.

The arrangement of the slots 20 is not limited to the example of the present embodiment in which V-shaped slots 20A and 20B form units that are spaced apart in the circumferential direction, and may be changed. For example, the slots 20 may be equally spaced in the circumferential direction.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A device for manufacturing a rotor, in which
the rotor includes
a rotor core having slots arranged in a circumferential direction, and
magnets respectively accommodated in the slots such that each of the magnets is sandwiched by two gaps in a width direction of the corresponding one of the slots, and
in a state in which the magnets are accommodated in the slots, the device is configured to fill the two gaps of each of the slots with a thermoplastic resin material to fix the magnets to the rotor core and manufacture the rotor, the device comprising:
a sprue configured to be connected to a nozzle of an injection device that injects the resin material;
gates, each facing one of the gaps in an axial direction of the rotor core in each of the slots; and
a runner portion connecting the sprue and the gates, wherein
the runner portion includes flow passages,
each of the flow passages includes
two first portions respectively extending from two of the gates respectively facing two of the gaps, and
a second portion connected to the two first portions and extending from the first portions to an upstream side in a flowing direction of the resin material, and
in each of the flow passages, at least one of the two first portions is connected to one of two first portions of one of the flow passages that is adjacent in the circumferential direction.

2. The device according to claim 1, wherein
the flow passages respectively correspond to branch flow passages,
the runner portion includes flow routes, and
each of the flow routes includes
two of the branch flow passages that are adjacent to each other in the circumferential direction, and
a third portion connected to the sprue and connecting the second portions of the branch flow passages that are adjacent to each other and extending from the second portions to the upstream side in the flowing direction.

3. The device according to claim 1, wherein
one of the two first portions of one of the flow passages is connected to one of the two first portions of an adjacent one of the flow passages on one side in the circumferential direction, and
the other one of the two first portions of the one of the flow passages is connected to one of the two first portions of another adjacent one of the flow passages on the other side in the circumferential direction.
